(19) United States
(12) Patent Application Publication
(10) Pub. No.: US 2020/0156741 A1
(43) Pub. Date: May 21, 2020

(54) BOIL-OFF GAS RELIQUEFACTION SYSTEM AND METHOD FOR SHIP AND METHOD FOR STARTING BOIL-OFF GAS RELIQUEFACTION SYSTEM FOR SHIP

(71) Applicant: DAEWOO SHIPBUILDING & MARINE ENGINEERING CO., LTD., Geoje-si, Gyeongsangnam-do (KR)

(72) Inventors: Joon Chae LEE, Seoul (KR); Dong Kyu CHOI, Seongnam-si (KR)

(21) Appl. No.: 16/635,479

(22) PCT Filed: Aug. 3, 2017
(86) PCT No.: PCT/KR2017/008373

§ 371 Date: Jan. 30, 2020

(30) Foreign Application Priority Data
Jul. 31, 2017 (KR) 10-2017-0097313
Aug. 1, 2017 (KR) 10-2017-0097805

(51) Int. Cl. B63B 25/16; F17C 9/02; B63H 21/38; F17C 6/00

(52) U.S. Cl. CPC B63B 25/16; F17C 9/02; F17C 2265/031; F17C 6/00; F17C 2265/033; F17C 2270/0105; B63H 21/38; F17C 2227/0185

(57) ABSTRACT

Disclosed is a boil-off gas reliquefaction system for vessels. The BOG reliquefaction system for vessels includes: a multistage compressor compressing BOG; a heat exchanger cooling the BOG compressed by the multistage compressor through heat exchange using BOG not compressed by the multistage compressor as a refrigerant; a pressure reducer disposed downstream of the heat exchanger and decompressing a fluid cooled by the heat exchanger; and a bypass line through which BOG is supplied to the multistage compressor after bypassing the heat exchanger.

### TECHNICAL FIELD

The present invention relates to a system and method for reliquefaction of boil-off gas generated in a storage tank using the boil-off gas as a refrigerant.

### BACKGROUND ART

Generally, natural gas is liquefied and transported over a long distance in the form of liquefied natural gas (LNG). Liquefied natural gas is obtained by cooling natural gas to a very low temperature of about −163° C. at atmospheric pressure and is well suited to long-distance transportation by sea because the volume thereof is significantly reduced, as compared with natural gas in a gaseous state.

Even when a liquefied natural gas storage tank is insulated, there is a limit to completely blocking external heat. Thus, liquefied natural gas is continuously vaporized in the liquefied natural gas storage tank by heat transferred into the storage tank. Liquefied natural gas vaporized in the storage tank is referred to as boil-off gas (BOG).

If the pressure in the storage tank exceeds a predetermined pressure due to generation of boil-off gas, the boil-off gas is discharged from the storage tank. The boil-off gas discharged from the storage tank is used as fuel for an engine, or is re-liquefied and returned to the storage tank.

Typically, a BOG reliquefaction system employs a cooling cycle for reliquefaction of BOG through cooling. Cooling of BOG is performed through heat exchange with a refrigerant and a partial reliquefaction system (PRS) using BOG itself as a refrigerant is used in the art.

FIG. 1 is a schematic block diagram of a typical partial reliquefaction system.

Referring to FIG. 1, in a typical partial reliquefaction system, BOG discharged from a storage tank T is compressed through multiple stages by a multistage compressor 200 and is cooled through heat exchange by a heat exchanger 100 using BOG discharged from the storage tank.

The fluid cooled by the heat exchanger 100 is expanded by a pressure reducer 300 so that some or all of the fluid is re-liquefied, and liquefied natural gas generated by reliquefaction of BOG is separated from BOG in a vapor phase by a gas/liquid separator 400.

### DISCLOSURE

### Technical Problem

Even for a reliquefaction system configured to treat all BOG generated during sailing of a vessel, there is a need for burning off an excess of BOG in the case of loading liquefied natural gas in a storage tank, and the like.

Embodiments of the present invention provide a vessel including a reliquefaction system capable of preparing for generation of an excess of BOG as well as normal operation.

### Technical Solution

In accordance with one aspect of the present invention, there is provided a boil-off gas (BOG) reliquefaction system for vessels, including: a multistage compressor compressing BOG; a heat exchanger cooling the BOG compressed by the multistage compressor through heat exchange using BOG not compressed by the multistage compressor as a refrigerant; a pressure reducer disposed downstream of the heat exchanger and decompressing a fluid cooled by the heat exchanger; and a bypass line through which BOG is supplied to the multistage compressor after bypassing the heat exchanger.

The BOG may be supplied to the multistage compressor after bypassing the heat exchanger along the bypass line when the heat exchanger cannot be used and/or when there is no need for reliquefaction of the BOG.

The multistage compressor may include at least one oil-lubrication type cylinder and, when a fluid channel of the heat exchanger is partially or completely blocked by condensed or solidified lubricant oil, the BOG may be supplied to the multistage compressor after bypassing the heat exchanger along the bypass line.

The BOG discharged from the storage tank may be used as a refrigerant in the heat exchanger, and some or all of the BOG may be supplied to the multistage compressor after bypassing the heat exchanger along the bypass line to satisfy an intake pressure condition of the multistage compressor, when a pressure of the BOG supplied to the multistage compressor does not satisfy the intake pressure condition of the multistage compressor and/or when there is a need to reduce an internal pressure of the storage tank to low pressure.

In accordance with another aspect of the present invention, there is provided a boil-off gas (BOG) reliquefaction system for vessels, including: a multistage compressor compressing BOG; a heat exchanger cooling the BOG compressed by the multistage compressor through heat exchange using BOG not compressed by the multistage compressor as a refrigerant; a pressure reducer disposed downstream of the heat exchanger and decompressing a fluid cooled by the heat exchanger; and a bypass line through which BOG is supplied to the multistage compressor after bypassing the heat exchanger, wherein the BOG is supplied to the multistage compressor after bypassing the heat exchanger along the bypass line upon start or restart of BOG reliquefaction.

The BOG compressed and increased in temperature by the multistage compressor may be supplied to a hot fluid channel of the heat exchanger.

A process of supplying the BOG compressed and increased in temperature by the multistage compressor to the hot fluid channel of the heat exchanger may be continued for a predetermined period of time to remove residues or foreign matter from the heat exchanger.

The predetermined period of time may be 2 minutes to 5 minutes.

The compressor may include at least one oil-lubrication type cylinder, and the residues may include BOG compressed by the compressor and sent to the heat exchanger upon previous BOG reliquefaction and lubricant oil mixed with the BOG compressed by the compressor.

The lubricant oil may be in a condensed or solidified state within the heat exchanger.

For the predetermined period of time, the BOG may be circulated through the bypass line, the multistage compressor, the hot fluid channel of the heat exchanger, and the pressure reducer.

After the predetermined period of time has elapsed, the BOG may be reliquefied by supplying BOG to a cold fluid channel of the heat exchanger so as to be used as a refrigerant in the heat exchanger.

Some of the BOG compressed by the multistage compressor may be supplied to a main engine.

The compressor may compress the BOG to a pressure of 150 bar to 350 bar.

The compressor may compress the BOG to a pressure of 80 bar to 250 bar.

The heat exchanger may include a microchannel type fluid channel.

The heat exchanger may be a printed circuit heat exchanger (PCHE).

In accordance with a further aspect of the present invention, there is provided a BOG reliquefaction method for vessels, including: 1) compressing BOG by a multistage compressor; 2) cooling the BOG compressed by the multistage compressor through heat exchange by a heat exchanger using BOG not compressed by the multistage compressor as a refrigerant; and 3) decompressing a fluid cooled by the heat exchanger by a pressure reducer, wherein the BOG is supplied to the multistage compressor after bypassing the heat exchanger along a bypass line.

The BOG may be supplied to the multistage compressor after bypassing the heat exchanger along the bypass line when the heat exchanger cannot be used and/or when there is no need for reliquefaction of the BOG.

The multistage compressor may include at least one oil-lubrication type cylinder and, when a fluid channel of the heat exchanger is partially or completely blocked by condensed or solidified lubricant oil, the BOG may be supplied to the multistage compressor after bypassing the heat exchanger along the bypass line.

It may be determined that it is time to remove the condensed or solidified lubricant oil, if performance of the heat exchanger is decreased to 60% to 80% of normal performance thereof.

It may be determined that it is time to remove the condensed or solidified lubricant oil based on at least one of a temperature difference between upstream of a cold fluid channel of the heat exchanger and downstream of a hot fluid channel of the heat exchanger (hereinafter, “temperature difference of a cold flow”); a temperature difference between downstream of the cold fluid channel of the heat exchanger and upstream of the hot fluid channel of the heat exchanger (hereinafter, “temperature difference of a hot flow”); and a pressure difference between upstream and downstream of the hot fluid channel (hereinafter, “pressure difference of the hot fluid channel”).

It may be determined that it is time to remove the condensed or solidified lubricant oil, when a state in which a lower value between the temperature difference of the cold flow and the temperature difference of the hot flow is a first preset value or more continues for a predetermined period of time or more or when a state in which the pressure difference of the hot fluid channel is a second preset value or more continues for a predetermined period of time or more.

The BOG may be circulated through the bypass line, the multistage compressor, the hot fluid channel of the heat exchanger, and the pressure reducer until the heat exchanger is normalized.

Circulation of the BOG may be continued until it is determined that the temperature of the hot fluid channel of the heat exchanger is increased to the temperature of the BOG compressed by the multistage compressor and sent to the hot fluid channel of the heat exchanger.

An engine may be driven during removal of the condensed or solidified lubricant oil.

BOG discharged from the storage tank may be used as a refrigerant in the heat exchanger, and some or all of the BOG may be supplied to the multistage compressor after bypassing the heat exchanger along the bypass line to satisfy an intake pressure condition of the multistage compressor, when a pressure of the BOG supplied to the multistage compressor does not satisfy the intake pressure condition of the multistage compressor and/or when there is a need to reduce an internal pressure of the storage tank to low pressure.

The compressor may compress the BOG to a pressure of 150 bar to 350 bar.

The compressor may compress the BOG to a pressure of 80 bar to 250 bar.

The heat exchanger may include a microchannel type fluid channel.

The heat exchanger may be a printed circuit heat exchanger (PCHE).

In accordance with a further aspect of the present invention, there is provided a method of starting a BOG reliquefaction system for vessels, including: compressing BOG by a multistage compressor; cooling the BOG compressed by the multistage compressor through heat exchange by a heat exchanger using BOG not compressed by the multistage compressor as a refrigerant; and decompressing a fluid cooled by the heat exchanger by a pressure reducer, wherein the BOG is supplied to the multistage compressor after bypassing the heat exchanger along a bypass line upon start or restart of BOG reliquefaction.

The BOG compressed and increased in temperature by the multistage compressor may be supplied to a hot fluid channel of the heat exchanger.

A process of supplying the BOG compressed and increased in temperature by the multistage compressor to the hot fluid channel of the heat exchanger may be continued for a predetermined period of time to remove residues or foreign matter from the heat exchanger.

The predetermined period of time may be 2 minutes to 5 minutes.

The compressor may include at least one oil-lubrication type cylinder, and the residues may include BOG compressed by the compressor and sent to the heat exchanger upon previous BOG reliquefaction and lubricant oil mixed with the BOG compressed by the compressor.

The lubricant oil may be in a condensed or solidified state within the heat exchanger.

For the predetermined period of time, the BOG may be circulated through the bypass line, the multistage compressor, the hot fluid channel of the heat exchanger, and the pressure reducer.

After the predetermined period of time has elapsed, the BOG may be reliquefied by supplying BOG to a cold fluid channel of the heat exchanger so as to be used as a refrigerant in the heat exchanger.

Some of the BOG compressed by the multistage compressor may be supplied to a main engine.

The compressor may compress the BOG to a pressure of 150 bar to 350 bar.

The compressor may compress the BOG to a pressure of 80 bar to 250 bar.

The heat exchanger may include a microchannel type fluid channel.

The heat exchanger may be a printed circuit heat exchanger (PCHE).

### Advantageous Effects

According to the present invention, it is possible to treat BOG even when the amount of BOG discharged from a storage tank exceeds an amount of BOG to be reliquefied using the BOG as a refrigerant.

According to the present invention, since cold heat of BOG sent to a gas combustion unit (GCU) can be used for reliquefaction of the BOG, it is possible to increase the amount of BOG to be reliquefied while decreasing the amount of BOG sent to the gas combustion unit. Thus, even in the event where an excess of BOG is generated, the amount of BOG to be burnt by the gas combustion unit can be reduced, thereby suppressing loss of liquefied natural gas during transportation by a vessel as much as possible.

According to the present invention, a bypass line through which the BOG is supplied after bypassing a heat exchanger can be used in various ways.

### DESCRIPTION OF DRAWINGS

FIG. 1 is a schematic block diagram of a typical partial reliquefaction system.

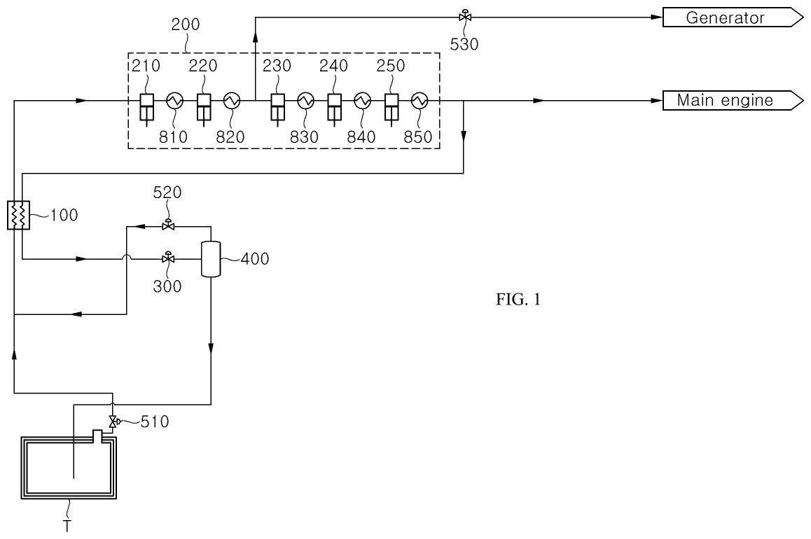

FIG. 2 is a schematic block diagram of a BOG reliquefaction system used in a vessel according to a first embodiment of the present invention.

FIG. 3 is a schematic block diagram of a BOG reliquefaction system used in a vessel according to a second embodiment of the present invention.

FIG. 4 is a schematic block diagram of a BOG reliquefaction system used in a vessel according to a third embodiment of the present invention.

### BEST MODE

Hereinafter, embodiments of the present invention will be described in detail with reference to the accompanying drawings. Vessels according to the present invention may be applied to various vessels, such as vessels equipped with engines fueled by natural gas, vessels including liquefied gas storage tanks, marine structures, and the like. It should be understood that the following embodiments can be modified in various ways and do not limit the scope of the present invention.

Although liquefied natural gas will be described by way of example in the following embodiments, it should be understood that the present invention can be applied to various kinds of liquefied gas and that the following embodiments can be modified in various ways and do not limit the scope of the present invention.

Further, fluid in each fluid supply line of a system according to the present invention may have a liquid phase, a vapor-liquid mixed phase, a vapor phase, and a supercritical fluid phase depending upon operation conditions of the system.

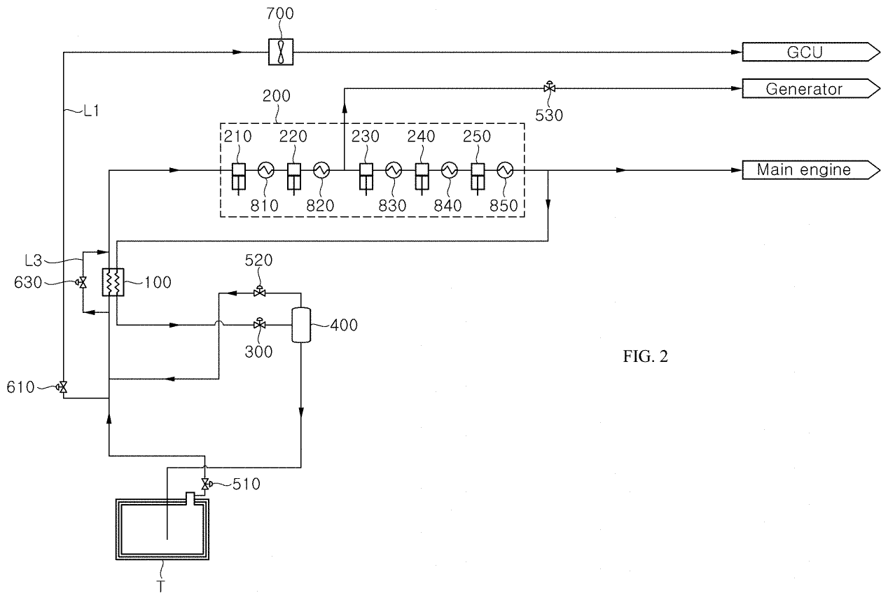

FIG. 2 is a schematic block diagram of a BOG reliquefaction system used in a vessel according to a first embodiment of the present invention.

Referring to FIG. 2, the BOG reliquefaction system included in the vessel according to this embodiment includes a multistage compressor 200, a heat exchanger 100, a pressure reducer 300, and a first discharge line L1.

Although the storage tank T is provided with a sealing and insulation barrier to store liquefied gas such as liquefied natural gas at cryogenic temperature, the storage tank T cannot completely block heat transfer from the outside and the internal pressure of the storage tank T can increase through continuous evaporation of liquefied gas therein. In order to maintain an appropriate level of the internal pressure by preventing excessive increase in internal pressure of the storage tank due to BOG, the BOG is discharged from the storage tank T.

A first control valve 510 for controlling the flow rate of BOG and opening/closing of a corresponding line may be disposed on a line through which BOG is discharged from the storage tank T.

The multistage compressor 200 according to this embodiment includes a plurality of compression cylinders 210, 220, 230, 240, 250 and a plurality of coolers 810, 820, 830, 840, 850, and compresses BOG discharged from the storage tank T through multiple stages. In this embodiment, the plural coolers 810, 820, 830, 840, 850 are disposed downstream of the plural compression cylinders 210, 220, 230, 240, 250 to be alternately arranged with the compression cylinders 210, 220, 230, 240, 250, and cools the BOG compressed and increased in temperature by the compression cylinders 210, 220, 230, 240, 250.

Some BOG compressed by the multistage compressor 200 may be supplied to a main engine of the vessel and the other BOG not to be used by the main engine may be supplied to the heat exchanger 100 so as to be subjected to a reliquefaction process.

The main engine may be an ME-GI engine that consists of two strokes and employs a diesel cycle in which high-pressure natural gas having a pressure of about 300 bar is directly injected into a combustion chamber near the piston's top dead center.

The ME-GI engine is known to use, as fuel, natural gas having a pressure of about 150 to 400 bar, preferably about 150 to 350 bar, more preferably about 300 bar.

The multistage compressor 200 can compress BOG to a pressure required by the main engine, for example, to a pressure of about 150 to 350 bar when the main engine is an ME-GI engine.

Instead of using the ME-GI engine as the main engine, an X-DF engine or a DF engine using BOG having a pressure of about 6 to 20 bar as fuel may be used. In this case, since the compressed BOG to be supplied to the main engine has a low pressure, the compressed BOG to be supplied to the main engine may be further compressed for reliquefaction. The BOG further compressed for reliquefaction may have a pressure of about 80 to 250 bar.

Some BOG having passed through some cylinders 210, 220 among the cylinders of the multistage compressor 200 may be divided and supplied to a generator. The generator according to this embodiment requires natural gas having a pressure of about 6.5 bar, and some BOG compressed to a pressure of 6.5 bar by some cylinders 210, 220 among the cylinders of the multistage compressor 200 may be supplied to the generator. A third control valve 530 for controlling the flow rate of BOG and opening/closing of a corresponding line may be disposed on a line through which the BOG is supplied from the multistage compressor 200 to the generator.

According to this embodiment, the heat exchanger 100 cools some or all of the BOG compressed by the multistage compressor 200 through heat exchange using the BOG discharged from the storage tank T.

If the heat exchanger 100 is not available, for example, upon overhaul or failure of the heat exchanger 100, the BOG discharged from the storage tank T may be allowed to bypass the heat exchanger 100 through a bypass line L3. According to this embodiment, the bypass line L3 is provided with a third shut-off valve 630 that opens or closes the bypass line L3. The third shut-off valve 630 is closed in normal times and is open when there is a need to use the bypass line L3.

The bypass line L3 may be used in the following cases.

1) In the Case where the Heat Exchanger Cannot be Used

Basically, the bypass line L3 is used in the case where the heat exchanger 100 is not available, for example, upon overhaul or failure of the heat exchanger 100. By way of example, in the case where the heat exchanger 100 is not available when some or all of the BOG compressed by the multistage compressor 200 is supplied to the main engine, reliquefaction of surplus BOG not used by the main engine is abandoned and BOG discharged from the storage tank T is directly supplied to the multistage compressor 200 to be compressed after bypassing the heat exchanger 100 along the bypass line L3. Then, the BOG compressed by the multistage compressor 200 is supplied to the main engine and the surplus BOG is sent to and burnt by a gas combustion unit.

2) For Removal of Condensed or Solidified Lubricant Oil

As an example of using the bypass line L3 for overhaul of the heat exchanger 100, when a fluid channel of the heat exchanger 100 is clogged by condensed or solidified lubricant oil, the condensed or solidified lubricant oil can be removed through the bypass line L3.

Some of the cylinders 210, 220, 230, 240, 250 included in the multistage compressor 200 may operate in an oil-free lubrication manner and the other may operate in an oil lubrication manner. In particular, when the BOG is compressed to 80 bar or more, preferably 100 bar or more in order to use the BOG compressed by the multistage compressor 200 as fuel of the main engine or for reliquefaction efficiency, the multistage compressor 200 includes an oil-lubrication type cylinder in order to compress the BOG to high pressure.

In the related art, lubricant oil for lubrication and cooling is supplied to the reciprocation type multistage compressor 200, for example, a piston sealing part thereof, in order to compress the BOG to 100 bar or more.

Since the lubricant oil is supplied to the oil-lubrication type cylinder, some lubricant oil is mixed with BOG having passed through the oil-lubrication type cylinder in the related art. The inventors of the present invention found that, since the lubricant oil mixed with the BOG is condensed or solidified prior to the BOG in the heat exchanger 100 and accumulated in the fluid channel of the heat exchanger 100, there is a need for removal of the condensed or solidified lubricant oil from the heat exchanger 100 after a certain period of time due to increase in amount of the condensed or solidified lubricant oil accumulated in the heat exchanger 100 over time.

Particularly, although it is desirable that the heat exchanger 100 according to this embodiment be a printed circuit heat exchanger (PCHE, also referred to as DCHE) in consideration of pressure and/or flow rate of BOG to be re-liquefied, reliquefaction efficiency, and the like, the PCHE has a narrow serpentine fluid channel (microchannel type fluid channel) and thus has a problem such as easy clogging of the fluid channel by the condensed or solidified lubricant oil, easy accumulation of the condensed or solidified lubricant oil at a serpentine portion of the fluid channel, and the like. The PCHE (DCHE) is manufactured by Kobelco Co., Ltd., Alfa Laval Co., LTd., and the like.

When the fluid channel of the heat exchanger 100 is clogged by the condensed or solidified lubricant oil, cooling efficiency of the heat exchanger 100 can be reduced. Therefore, if performance of the heat exchanger 100 falls below a preset value of normal performance, it can be estimated that the condensed or solidified lubricant oil is accumulated in a certain amount or more in the heat exchanger 100. By way of example, it can be determined that it is time to remove the condensed or solidified lubricant oil from the heat exchanger 100 if the performance of the heat exchanger 100 falls to about 50% to about 90% of normal performance, preferably about 60% to about 80%, more preferably about 70% or less.

Herein, the range of “about 50% to about 90%” of normal performance includes all of values of about 50% or less, about 60% or less, about 70% or less, about 80% or less, and about 90% or less, and the range of “about 60% to about 80%” of normal performance include all of values of about 60% or less, about 70% or less, and about 80% or less.

When the performance of the heat exchanger 100 deteriorates, it can be determined whether it is time to remove the condensed or solidified lubricant oil, based on a temperature difference of cold fluid supplied to the heat exchanger 100 or discharged from the heat exchanger 100 (that is, a temperature difference between upstream of a cold fluid channel of the heat exchanger 100 and downstream of a hot fluid channel thereof, hereinafter referred to as “temperature difference of the cold flow”), a temperature difference of hot fluid supplied to the heat exchanger 100 or discharged from the heat exchanger 100 (that is, a temperature difference between downstream of the cold fluid channel of the heat exchanger 100 and upstream the hot fluid channel thereof, hereinafter referred to as “temperature difference of the hot flow”), and a pressure difference between upstream and downstream of the hot fluid channel of the heat exchanger 100 (hereinafter referred to as “pressure difference of the hot fluid channel”), and the like.

The cold fluid channel of the heat exchanger 100 refers to a fluid channel through which the BOG discharged from the storage tank T is supplied to the heat exchanger 100, and the hot fluid channel of the heat exchanger 100 refers to a fluid channel through which the BOG compressed by the multistage compressor 200 is supplied thereto.

Since the BOG discharged from the storage tank T is not mixed with oil or has a trace amount of oil and a time point at which the lubricant oil is mixed with the BOG is when the BOG is compressed by the multistage compressor 200, the condensed or solidified lubricant oil is not substantially accumulated in the cold fluid channel of the heat exchanger 100, which uses the BOG discharged from storage tank T as a refrigerant and then supplies the BOG to the multistage compressor 200, and is accumulated in the hot fluid channel of the heat exchanger 100, in which the BOG compressed by the multistage compressor 200 is cooled and supplied to the pressure reducer 600.

Accordingly, since the pressure difference between the upstream and downstream of the heat exchanger 100 due to clogging of the fluid channel by the condensed or solidified lubricant oil rapidly increases in the hot fluid channel, it is desirable to determine whether it is time to remove the condensed or solidified lubricant oil by measuring the pressure of the hot fluid channel of the heat exchanger 100.

Considering that the PCHE having a narrow and serpentine fluid channel can be used as the heat exchanger according to this embodiment, determination as to whether it is time to remove the condensed or solidified lubricant oil based on the pressure difference between upstream and downstream of the heat exchanger 100 can be advantageously used.

More specifically, it can be determined that it is time to remove the condensed or solidified lubricant oil, when a state wherein a lower value between the temperature difference of the cold flow and the temperature difference of the hot flow is a first preset value or more continues for a predetermined period of time or more, or when a state wherein the pressure difference of the hot fluid channel is a second preset value or more continues for a predetermined period of time or more.

The first preset value ranges from about 20° C. to about 50° C., preferably from about 30° C. to about 40° C., more preferably about 35° C.; the second preset value ranges from about 1 bar to about 5 bar, preferably from about 1.5 bar to about 3 bar, more preferably about 2 bar (200 kPa); and the predetermined period of time may be about 1 hour.

If it is determined that it is time to remove the condensed or solidified lubricant oil, the process of removing the condensed or solidified lubricant oil through the bypass line L3 is performed.

The BOG discharged from the storage tank T is sent to the multistage compressor 200 through the bypass line L3 and is prevented from being supplied to the heat exchanger 100. Therefore, the refrigerant is not supplied to the heat exchanger 100.

The BOG discharged from the storage tank T bypasses the heat exchanger 100 through the bypass line L3 and is then sent to the multistage compressor 200. The BOG sent to the multistage compressor 200 undergoes increase in temperature and pressure while being compressed by the multistage compressor 200. The BOG compressed to about 300 bar by the multistage compressor 200 has a temperature of about 40° C. to about 45° C.

When the BOG compressed by the multistage compressor 200 is continuously supplied to the heat exchanger 100, the cold BOG used as a refrigerant in the heat exchanger 100 and discharged from the storage tank T is not supplied to the heat exchanger 100 and the hot BOG is continuously supplied to the heat exchanger 100, thereby gradually increasing the temperature of the hot fluid channel of the heat exchanger 100, through which the BOG compressed by the compressor 200 passes.

When the temperature of the hot fluid channel of the heat exchanger 100 exceeds a condensation or solidification point of the lubricant oil, the condensed or solidified lubricant oil accumulated in the heat exchanger 100 gradually melts or decreases in viscosity, and then the melted or low viscosity lubricant oil is mixed with the BOG and exits the heat exchanger 100.

As the temperature of the hot fluid channel of the heat exchanger 100 increases, the condensed or solidified lubricant oil accumulated in the heat exchanger 100 gradually melts or decreases in viscosity and is then sent to a gas/liquid separator 700 after being mixed with the BOG. In the process of removing the condensed or solidified lubricant oil in the heat exchanger 100 through the bypass line L3, since the BOG is not re-liquefied, the re-liquefied gas is not collected in the gas/liquid separator 700, and the BOG and the melted or low viscosity lubricant oil are collected.

The gaseous BOG collected in the gas/liquid separator 700 is discharged from the gas/liquid separator 700 and sent to the multistage compressor 200 along the bypass line L3.

When the condensed or solidified lubricant oil is removed through the bypass line L3, the BOG is circulated through the bypass line L3, the multistage compressor 200, the hot fluid channel of the heat exchanger 100, the pressure reducer 300 and the gas/liquid separator 400 until the heat exchanger 100 is normalized, and this circulation process continues until it is determined that the temperature of the hot fluid channel of the heat exchanger 100 is increased to the temperature of the BOG compressed by the multistage compressor 200 and sent to the hot fluid channel of the heat exchanger 100. Alternatively, the circulation process may also be continued until it is empirically determined that a sufficient time has passed.

If it is determined that most of the condensed or solidified lubricant oil in the heat exchanger 100 is collected in the gas/liquid separator 700 (that is, if it is determined that the heat exchanger 100 is normalized), the melted or low viscosity lubricant oil is discharged from the gas/liquid separator 400 by blocking the BOG compressed by the multistage compressor 200 from flowing into the heat exchanger 100.

In order to rapidly discharge the melted or low viscosity lubricant oil from the gas/liquid separator 400, nitrogen may be supplied into the gas/liquid separator 400 (nitrogen purging). Upon nitrogen purging, nitrogen may be supplied at a pressure of about 5 bar to about 7 bar into the gas/liquid separator 400.

In addition to the condensed or solidified lubricant oil inside the heat exchanger 100, the condensed or solidified lubricant oils accumulated in pipes, valves, instruments, and other equipment can also be removed through the aforementioned processes.

According to the present invention, an engine (main engine and/or power generation engine) may be driven during removal of the condensed or solidified lubricant oil from the heat exchanger 100. If the engine can be driven during removal of the condensed or solidified lubricant oil from the heat exchanger 100, since it is possible to overhaul the heat exchanger 100 during operation of the engine, there are advantages in that it is possible to propel the vessel and generate power and to remove the condensed or solidified lubricant oil using surplus BOG during overhaul of the heat exchanger 100.

Furthermore, when the engine is driven during removal of the condensed or solidified lubricant oil from the heat exchanger 100, there is an advantage in that it is possible to burn the lubricant oil mixed with the BOG during compression by the compressor 200. That is, the engine is used not only for the purpose of propelling the vessel or power generation, but also for removing the oil mixed with the BOG.

3) In the Case where there is No Need for Reliquefaction of BOG

In addition, if there is no need for reliquefaction of the BOG due to little surplus BOG as in a ballast condition of the vessel, all of the BOG discharged from the storage tank T may be sent to the bypass line L3 so as to allow all of the BOG to be directly sent to the multistage compressor 200 after bypassing the heat exchanger 100. The BOG compressed by the multistage compressor 200 is used as fuel for the main engine. If it is determined that there is no need for reliquefaction of the BOG due to little surplus BOG, the third shut-off valve 630 may be controlled to be automatically opened.

The inventors of the present invention found that, when the BOG is supplied to the engine through the heat exchanger having a narrow fluid channel according to the present invention, the BOG suffers from a severe pressure drop due to the heat exchanger. If there is no need for reliquefaction of the BOG, fuel can be smoothly supplied to the engine by compressing the BOG while bypassing the heat exchanger 100, as described above.

4) Upon Start or Restart of BOG Reliquefaction

The bypass line L3 may also be used for reliquefaction of BOG due to increase in the amount of BOG not re-liquefied.

When there is a need for reliquefaction of the BOG due to increase in the amount of BOG (that is, upon start or restart of BOG reliquefaction), all of the BOG discharged from the storage tank T may be sent to the bypass line L3 so as to allow all of the BOG to be directly sent to the multistage compressor 200 after bypassing the heat exchanger 100, and the BOG compressed by the multistage compressor 200 may be sent to the hot fluid channel of the heat exchanger 100. Some of the BOG compressed by the multistage compressor 200 may be supplied to the main engine.

When the temperature of the hot fluid channel of the heat exchanger 100 is increased through the aforementioned process upon start or restart of BOG reliquefaction, there is an advantage in that BOG reliquefaction can be started after removing any condensed or solidified lubricant oil, other residues or impurities that can remain in the heat exchanger 100, other equipment, pipes, and the like in a previous BOG reliquefaction process.

Residues may include BOG, which is compressed by the multistage compressor 200 and then supplied to the heat exchanger in previous BOG liquefaction, and lubricant oil mixed with the BOG compressed by the multistage compressor 200.

If the cold BOG discharged from the storage tank T is directly supplied to the heat exchanger 100 without increasing the temperature of the heat exchanger 100 through the bypass line L3 upon start or restart of BOG reliquefaction, the cold BOG discharged from the storage tank T is sent to the cold fluid channel of the heat exchanger 100 in a state that the hot BOG is not sent to the hot fluid channel of the heat exchanger 100. As a result, the lubricant oil remaining in a non-condensed or non-solidified state in the heat exchanger 100 can also be condensed or solidified as the temperature of the heat exchanger 100 decreases.

When the bypass line L3 is used to increase the temperature of the heat exchanger 100 for a certain period of time (if it is determined that the condensed or solidified lubricant oil or other impurities are almost completely removed, the certain period of time can be determined by those skilled in the art and may be about 1 minute to about 30 minutes, preferably about 3 minutes to about 10 minutes, and more preferably about 2 minutes to about 5 minutes), BOG reliquefaction is started by slowly opening the first valve 510 and the second valve 520 while slowly closing the third shut-off valve 630. As time further elapses, the first valve 510 and the second valve 520 are completely opened and the third shut-off valve 630 is completely closed to allow all of the BOG discharged from the storage tank T to be used as a refrigerant for reliquefaction of the BOG in the heat exchanger 100.

5) To Satisfy Intake Pressure Condition of Multistage Compressor

In addition, the bypass line L3 may be used to satisfy the intake pressure condition of the multistage compressor 200 when the internal pressure of the storage tank T is low.

The multistage compressor 200 often does not satisfy the intake pressure condition upstream of the multistage compressor 200 in the case where the storage tank T has a low internal pressure, such as when the amount of generated BOG is small due to a small amount of liquefied gas in the storage tank T or if the amount of BOG supplied to the engine for propulsion of the vessel is large due to high speed of the vessel.

Particularly, in the PCHE (DCHE) used as the heat exchanger 100, the pressure drop is large due to a narrow fluid channel thereof when the BOG discharged from the storage tank T passes through the PCHE.

Conventionally, when the multistage compressor 200 fails to satisfy the intake pressure condition, the multistage compressor 200 is protected by recycling some or all of BOG through recirculation lines disposed in the multistage compressor 200.

However, if the intake pressure condition of the multistage compressor 200 is satisfied by recirculating the BOG, the amount of the BOG compressed by the multistage compressor 200 is decreased, thereby causing deterioration in reliquefaction performance and failing to satisfy fuel consumption requirements of an engine. Particularly, if the engine does not satisfy the fuel consumption requirements, operation of the vessel can be significantly disturbed. Therefore, there is a need for a BOG reliquefaction method capable of satisfying the intake pressure condition for the multistage compressor 200 and fuel consumption requirements of the engine even when the internal pressure of the storage tank T is low.

According to the present invention, instead of providing additional equipment, the bypass line L3 provided for maintenance and overhaul of the heat exchanger 100 may be used to satisfy the intake pressure condition of the multistage compressor 200 without decreasing the amount of the BOG compressed by the multistage compressor 200 even when the internal pressure of the storage tank T is low.

According to the present invention, when the internal pressure of the storage tank T is decreased to a preset value or less, the third shut-off valve 630 is opened to allow some or all of the BOG discharged from the storage tank T to be directly sent to the multistage compressor 200 through the bypass line L3 bypassing the heat exchanger 100.

The amount of BOG sent to the bypass line L3 can be adjusted depending upon the pressure of the storage tank T compared with the intake pressure condition required by the multistage compressor 200. That is, all of the BOG discharged from the storage tank T may be sent to the bypass line L3 by opening the third shut-off valve 630, or only some of the BOG discharged from the storage tank T may be sent to the bypass line L3 and the remaining BOG may be sent to the heat exchanger 100 by partially opening the third shut-off valve 630. Pressure drop of the BOG decreases with increasing amount of the BOG bypassing the heat exchanger 100 through the bypass line L3.

Although there is an advantage of minimizing the pressure drop when the BOG discharged from the storage tank T is directly sent to the multistage compressor 200 after bypassing the heat exchanger 100, cold heat of the BOG cannot be used for reliquefaction of the BOG. Thus, use of the bypass line L3 to reduce the pressure drop and the amount of the BOG to be sent to the bypass line L3 among the amount of the BOG discharged from the storage tank T are determined based on the internal pressure of the storage tank T, fuel consumption requirements of the engine, the amount of the BOG to be re-liquefied, and the like.

By way of example, it can be determined that it is advantageous to reduce the pressure drop using the bypass line L3 when the internal pressure of the storage tank T is a preset value or less and the vessel is operated at a predetermined speed or more. Specifically, it can be determined that it is advantageous to reduce the pressure drop using the bypass line L3 when the internal pressure of the storage tank T is 1.09 bar or less and the speed of the vessel is 17 knots or more.

In addition, the intake pressure condition of the multistage compressor 200 is not often satisfied even when all of the BOG discharged from the storage tank T is sent to the multistage compressor 200 through the bypass line L3. In this case, the intake pressure condition can be satisfied using the recirculation lines disposed inside the heat exchanger 100.

That is, when the intake pressure condition of the multistage compressor 200 cannot be satisfied due to reduction in pressure of the storage tank T, the multistage compressor 200 is protected using the recirculation lines in the related art, whereas, according to the present invention, the bypass line L3 is primarily used in order to satisfy the intake pressure condition of the multistage compressor 200, and the recirculation lines are secondarily used when the intake pressure condition of the compressor 200 cannot be satisfied even after sending all of the BOG discharged from the storage tank T to the multistage compressor through the bypass line L3.

In order to satisfy the intake pressure condition of the compressor 200 through primary use of the bypass line L3 and secondary use of the recirculation lines, a pressure condition under which the third shut-off valve 630 is open is set to a higher value than a pressure condition under which the recirculation valves are open.

The condition under which the recirculation valves are open and the condition under which the third shut-off valve 630 is open are preferably determined based on pressure upstream of the compressor 200. Alternatively, these conditions may be determined based on the internal pressure of the storage tank T.

The pressure upstream of the multistage compressor 200 may be measured by a first pressure sensor (not shown) disposed upstream of the multistage compressor 200 and the internal pressure of the storage tank T may be measured by a second pressure sensor (not shown).

The third shut-off valve 630 is a valve providing a higher response than a typical valve in order to allow rapid regulation of the degree of opening depending upon pressure change of the storage tank T.

6) In the Case where the Internal Pressure of the Storage Tank is Reduced to Low Pressure

Furthermore, when there is a need to reduce the internal pressure of the storage tank T to low pressure, the bypass line L3 may be used to satisfy the intake pressure condition of the multistage compressor 200 even when the internal pressure of the storage tank T is reduced.

The pressure reducer 300 according to this embodiment expands the BOG compressed by the multistage compressor 200 and then cooled by the heat exchanger 100. Some or all of the BOG is re-liquefied through compression by the multistage compressor 200, cooling by the heat exchanger 100, and pressure reduction by the pressure reducer 300. The pressure reducer 300 according to this embodiment may be an expansion valve, such as a Joule-Thomson valve, or may be an inflator.

The first discharge line L1 according to this embodiment is branched from the line, through which the BOG discharged from the storage tank T is sent to the heat exchanger 100, to send some or all of BOG discharged from the storage tank T to a gas combustion unit.

The BOG reliquefaction system included in the vessel according to this embodiment allows some or all of the BOG generated in the storage tank T to be sent to and burnt by the gas combustion unit through the first discharge line L1, and thus can prepare for the case where an excess of the BOG is generated in the storage tank T, for example, upon loading liquefied natural gas and the like.

The first discharge line L1 is provided with a first shut-off valve 610 which opens or closes the first discharge line L1, and a blower 700 disposed downstream of the first shut-off valve 610 to intake and send the BOG to the gas combustion unit.

The BOG reliquefaction system provided to the vessel according to this embodiment may further include the gas/liquid separator 400 disposed downstream of the pressure reducer 300 to separate the BOG remaining in a vapor phase from liquefied natural gas generated by reliquefaction of the BOG through the multistage compressor 200, the heat exchanger 100 and the pressure reducer 300.

The liquefied gas separated by the gas/liquid separator 400 may be sent to the storage tank T and the BOG separated by the gas/liquid separator 400 may be combined with the BOG discharged from the storage tank T and be sent to the heat exchanger 100.

A joining point at which the BOG separated by the gas/liquid separator 400 is combined with the BOG discharged from the storage tank T may be disposed between a branch point of the first discharge line L1 and the heat exchanger 100. That is, on the line through which the BOG discharged from the storage tank T is sent to the heat exchanger 100, the branch point of the first discharge line L1 and the joining point of the BOG separated by the gas/liquid separator 400 may be sequentially disposed in the flow direction of the BOG.

Although FIG. 2 shows the structure wherein the BOG separated by the gas/liquid separator 400 is combined with the BOG discharged from the storage tank T between the branch point of the first discharge line L1 and the heat exchanger 100, the BOG separated by the gas/liquid separator 400 according to this embodiment may be combined therewith between the storage tank T and the branch point of the first discharge line L1. That is, on the line through which the BOG discharged from the storage tank T is sent to the heat exchanger 100, the joining point of the BOG separated by the gas/liquid separator 400 and the branch point of the first discharge line L1 may be sequentially disposed in the flow direction of the BOG.

In the structure wherein the joining point of the BOG separated by the gas/liquid separator 400 is disposed between the branch point of the first discharge line L1 and the heat exchanger 100, some or all of the BOG discharged from the storage tank T is sent to the gas combustion unit along the first discharge line L1 and all of the BOG separated by the gas/liquid separator 400 is sent to the heat exchanger 100.

In the BOG reliquefaction system according to this embodiment, a second control valve 520 for controlling the flux of BOG and opening/closing of a corresponding line may be disposed on the line through which the gaseous BOG separated by the gas/liquid separator 400 is discharged.

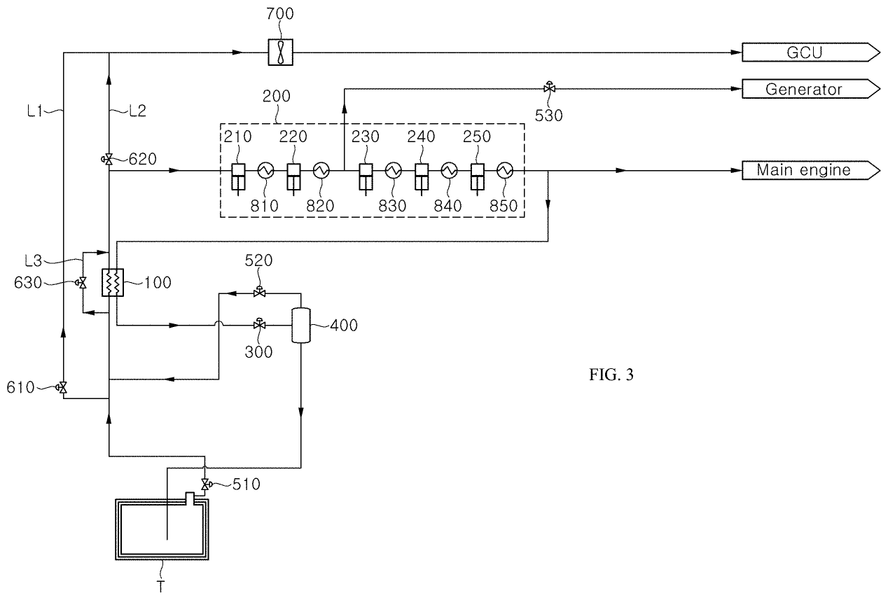

FIG. 3 is a schematic block diagram of a BOG reliquefaction system used in a vessel according to a second embodiment of the present invention.

The BOG reliquefaction system included in the vessel according to the second embodiment shown in FIG. 3 is different from the BOG reliquefaction system included in the vessel according to the first embodiment shown in FIG. 2 except that the BOG reliquefaction system according to the second embodiment further includes a second discharge line L2, and the following description will focus on the different configuration of the second embodiment. Detailed descriptions of the same components as those of the BOG reliquefaction system included in the vessel according to the first embodiment will be omitted.

Referring to FIG. 3, as in the first embodiment, the BOG reliquefaction system included in the vessel according to the second embodiment includes a multistage compressor 200, a heat exchanger 100, a pressure reducer 300, and a first discharge line L1.

As in the first embodiment, a first control valve 510 for controlling the flow rate of BOG and opening/closing of a corresponding line may be disposed on a line from which BOG is discharged from the storage tank T.

As in the first embodiment, the multistage compressor 200 according to this embodiment includes a plurality of compression cylinders 210, 220, 230, 240, 250 and a plurality of coolers 810, 820, 830, 840, 850, and compresses BOG discharged from the storage tank T through multiple stages.

As in the first embodiment, some BOG compressed by the multistage compressor 200 may be supplied to a main engine for propelling the vessel and the other BOG not to be used by the main engine may be supplied to the heat exchanger 100 so as to be subjected to a reliquefaction process.

As in the first embodiment, the main engine may be an ME-GI engine.

As in the first embodiment, the multistage compressor 200 can compress BOG to a pressure required by the main engine, for example, to a pressure of about 150 to 350 bar when the main engine is an ME-GI engine.

Some BOG having passed through some cylinders 210, 220 among the cylinders of the multistage compressor 200 may be divided and supplied to a generator. The generator according to this embodiment requires natural gas having a pressure of about 6.5 bar, and some BOG compressed to a pressure of 6.5 bar by some cylinders 210, 220 among the cylinders of the multistage compressor 200 may be supplied to the generator. A third control valve 530 for controlling the flow rate of BOG and opening/closing of a corresponding line may be disposed on the line through which the BOG is supplied from the multistage compressor 200 to the generator.

According to this embodiment, the heat exchanger 100 cools some or all of the BOG compressed by the multistage compressor 200 through heat exchange using the BOG discharged from the storage tank T.

As in the first embodiment, if the heat exchanger 100 is not available, for example, upon overhaul or failure of the heat exchanger 100, BOG discharged from the storage tank T may be allowed to bypass the heat exchanger 100 through a bypass line L3. According to this embodiment, the bypass line L3 is provided with a third shut-off valve 630 that opens or closes the bypass line L3.

As in the first embodiment, the bypass line L3 according to this embodiment may be used in order to satisfy an intake pressure condition of the multistage compressor 200 even when the pressure of the storage tank T is reduced, 1) in the case where the heat exchanger cannot be used, for example, upon overhaul or failure of the heat exchanger 100, 2) for removal of condensed or solidified lubricant oil when the fluid channel of the heat exchanger 100 is clogged by condensed or solidified lubricant oil, 3) when there is no need for reliquefaction of BOG due to little surplus BOG, 4) when there is a need for reliquefaction of BOG due to increase in the amount of BOG (that is, upon start or restart of BOG reliquefaction), 5) for satisfaction of the intake pressure condition of the multistage compressor 200 when the internal pressure of the storage tank T is low, and 6) in the cases where the internal pressure of the storage tank T is reduced to low pressure.

As in the first embodiment, the pressure reducer 300 according to this embodiment expands the BOG compressed by the multistage compressor 200 and then cooled by the heat exchanger 100. As in the first embodiment, some or all of the BOG is re-liquefied through compression by the multistage compressor 200, cooling by the heat exchanger 100, and pressure reduction by the pressure reducer 300. The pressure reducer 300 according to this embodiment may be an expansion valve, such as a Joule-Thomson valve, or may be an inflator.

As in the first embodiment, the first discharge line L1 according to this embodiment is branched from the line through which the BOG discharged from the storage tank T is sent to the heat exchanger 100, to send some or all of the BOG discharged from the storage tank T to a gas combustion unit.

As in the first embodiment, the first discharge line L1 according to this embodiment is provided with a first shut-off valve 610 which opens or closes the first discharge line L1, and a blower 700 disposed downstream of the first shut-off valve 610 to intake and send the BOG to the gas combustion unit.

The BOG reliquefaction system provided to the vessel according to this embodiment may further include a second discharge line L2 branched from the line, through which the BOG is sent from the heat exchanger 100 to the multistage compressor 200, and joined to the first discharge line L1. A second shut-off valve 620 for opening or closing the second discharge line L2 may be disposed on the second discharge line L2.

According to this embodiment, the first discharge line L1 is used to send the BOG from the storage tank T to the gas combustion unit after bypassing the heat exchanger 100 in the case where the heat exchanger 100 is not available, for example, upon overhaul or failure of the heat exchanger 100, and the second discharge line L2 is used when there is a need to send the BOG discharged from the storage tank T to the gas combustion unit in a state that the heat exchanger 100 can be used.

Although the BOG reliquefaction system includes both the first discharge line L1 and the second discharge line L2 in this embodiment, the BOG reliquefaction system according to the present invention may be configured such that the second discharge line L2 branched between the heat exchanger 100 and the multistage compressor 200 is directly connected to the gas combustion unit without including the first discharge line L1 branched between the storage tank T and the heat exchanger 100.

In the first embodiment shown in FIG. 2, since the BOG discharged from the storage tank T and sent to the gas combustion unit is branched upstream of the heat exchanger 100, only the BOG discharged from the storage tank T and sent to the multistage compressor 200 is used as a refrigerant in the heat exchanger 100.

According to the second embodiment, however, since the BOG is sent to the gas combustion unit through the second discharge line L2 branched downstream of the heat exchanger 100, both the BOG discharged from the storage tank T and sent to the gas combustion unit and the BOG discharged from the storage tank T and sent to the multistage compressor 200 are used as a refrigerant for the heat exchanger 100.

Accordingly, the heat exchanger 100 of the BOG reliquefaction system according to this embodiment can have higher cooling efficiency than that of the BOG reliquefaction system according to the first embodiment. As the cooling efficiency of the heat exchanger 100 is increased, the amount of reliquefied BOG increases and surplus BOG is reliquefied or sent to the gas combustion unit, thereby reducing the amount of BOG to be sent to and burnt by the gas combustion unit.

The heat exchanger 100 according to this embodiment is designed to have a larger capacity than the heat exchanger according to the first embodiment in order to accommodate the BOG sent to the gas combustion unit.

According to this embodiment, the second discharge line L2 is preferably joined to the first discharge line L1 downstream of the first shut-off valve 610. In the structure wherein the BOG reliquefaction system includes the blower 700, the second discharge line L2 is preferably joined to the first discharge line L1 between the first shut-off valve 610 and the blower 700.

The BOG reliquefaction system included in the vessel according to this embodiment allows some or all of the BOG generated in the storage tank T to be sent to and burnt by the gas combustion unit through the first discharge line L1 or the second discharge line L2, and thus can prepare for the case where an excess of the BOG is generated in the storage tank T, for example, upon loading liquefied natural gas and the like.

As in the first embodiment, the BOG reliquefaction system provided to the vessel according to this embodiment may further include a gas/liquid separator 400 disposed downstream of the pressure reducer 300 to separate the BOG remaining in a vapor phase from liquefied natural gas generated by reliquefaction of the BOG through the multistage compressor 200, the heat exchanger 100 and the pressure reducer 300.

As in the first embodiment, according to this embodiment, the liquefied gas separated by the gas/liquid separator 400 may be sent to the storage tank T and the BOG separated by the gas/liquid separator 400 may be combined with the BOG discharged from the storage tank T and be sent to the heat exchanger 100.

As in the first embodiment, according to this embodiment, a joining point at which the BOG separated by the gas/liquid separator 400 is combined with the BOG discharged from the storage tank T may be disposed between a branch point of the first discharge line L1 and the heat exchanger 100. That is, as in the first embodiment, according to this embodiment, the BOG separated by the gas/liquid separator 400 may be combined therewith between the storage tank T and the branch point of the first discharge line L1.

As in the first embodiment, in the structure wherein the joining point of the BOG separated by the gas/liquid separator 400 is disposed between the branch point of the first discharge line L1 and the heat exchanger 100, some or all of the BOG discharged from the storage tank T is sent to the gas combustion unit along the first discharge line L1 and all of the BOG separated by the gas/liquid separator 400 is sent to the heat exchanger 100.

In the BOG reliquefaction system according to this embodiment, a second control valve 520 for controlling the flux of BOG and opening/closing of the corresponding line may be disposed on the line through which the gaseous BOG separated by the gas/liquid separator 400 is discharged.

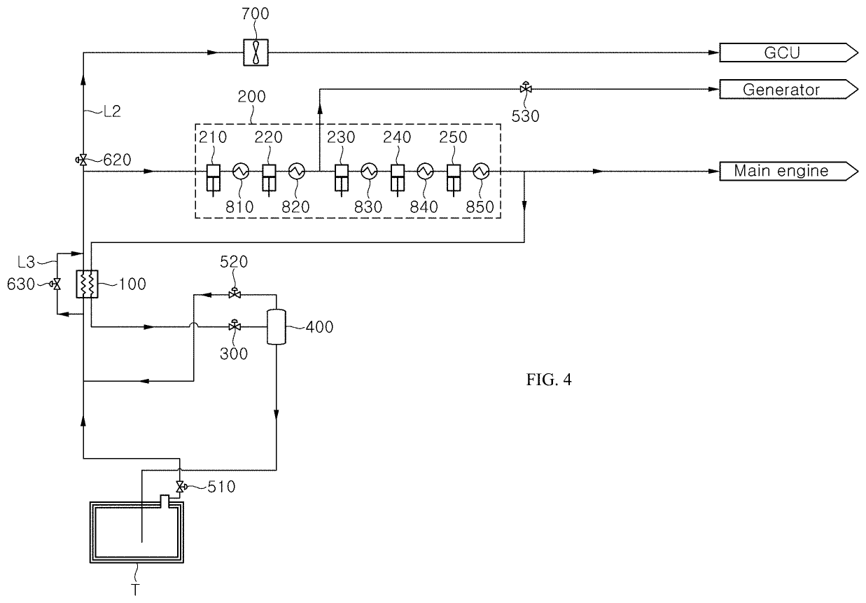

FIG. 4 is a schematic block diagram of a BOG reliquefaction system used in a vessel according to a third embodiment of the present invention.

The BOG reliquefaction system included in the vessel according to the third embodiment shown in FIG. 4 is different from the BOG reliquefaction system included in the vessel according to the first embodiment shown in FIG. 2 except that the BOG reliquefaction system according to the third embodiment does not include first discharge line L1 and further includes a second discharge line L2, and the following description will focus on the different configuration of the second embodiment. Detailed descriptions of the same components as those of the BOG reliquefaction system included in the vessel according to the first embodiment will be omitted.

Referring to FIG. 4, as in the first embodiment, the BOG reliquefaction system included in the vessel according to the third embodiment includes a multistage compressor 200, a heat exchanger 100, and a pressure reducer 300. However, the BOG reliquefaction system included in the vessel according to the third embodiment includes the second discharge line L2 without including the first discharge line L1.

As in the first embodiment, a first control valve 510 for controlling the flow rate of BOG and opening/closing of a corresponding line may be disposed on the line from which BOG is discharged from the storage tank T.

As in the first embodiment, the multistage compressor 200 according to this embodiment includes a plurality of compression cylinders 210, 220, 230, 240, 250 and a plurality of coolers 810, 820, 830, 840, 850, and compresses BOG discharged from the storage tank T through multiple stages.

As in the first embodiment, some BOG compressed by the multistage compressor 200 may be supplied to a main engine for propelling the vessel and the other BOG not to be used by the main engine may be supplied to the heat exchanger 100 so as to be subjected to a reliquefaction process.

As in the first embodiment, the main engine may be an ME-GI engine.

As in the first embodiment, the multistage compressor 200 can compress BOG to a pressure required by the main engine, for example, to a pressure of about 150 to 350 bar when the main engine is an ME-GI engine.

As in the first embodiment, some BOG having passed through some cylinders 210, 220 among the cylinders of the multistage compressor 200 may be divided and supplied to a generator. The generator according to this embodiment requires natural gas having a pressure of about 6.5 bar, and some BOG compressed to a pressure of 6.5 bar by some cylinders 210, 220 among the cylinders of the multistage compressor 200 may be supplied to the generator. As in the first embodiment, a third control valve 530 for controlling the flow rate of BOG and opening/closing of a corresponding line may be disposed on the line through which the BOG is supplied from the multistage compressor 200 to the generator.

According to this embodiment, the heat exchanger 100 cools some or all of the BOG compressed by the multistage compressor 200 through heat exchange using the BOG discharged from the storage tank T, as in the first embodiment.

As in the first embodiment, the pressure reducer 300 according to this embodiment expands the BOG compressed by the multistage compressor 200 and then cooled by the heat exchanger 100. As in the first embodiment, some or all of the BOG is re-liquefied through compression by the multistage compressor 200, cooling by the heat exchanger 100, and pressure reduction by the pressure reducer 300. The pressure reducer 300 according to this embodiment may be an expansion valve, such as a Joule-Thomson valve, or may be an inflator.

According to this embodiment, the second discharge line L2 is branched from the line through which the BOG is sent from the heat exchanger 100 to the multistage compressor 200, and sends some or all of the BOG, which has been discharged from the storage tank T and used as a refrigerant in the heat exchanger 100, to the gas combustion unit.

According to this embodiment, a second shut-off valve 620 for opening or closing the second discharge line L2 may be disposed on the second discharge line L2, and a blower 700 may be disposed downstream of the second shut-off valve 620 to intake and send the BOG to the gas combustion unit.

According to this embodiment, the BOG discharged from the storage tank T is allowed to bypass the heat exchanger 100 along the bypass line L3 in the case where the heat exchanger 100 is not available, for example, upon overhaul or failure of the heat exchanger 100, and the BOG discharged from the storage tank T is sent to the heat exchanger 100 to be used as a refrigerant and then sent to the gas combustion unit along the second discharge line L2 when there is a need to send the BOG discharged from the storage tank T to the gas combustion unit in a state that the heat exchanger 100 can be used. According to this embodiment, the bypass line L3 is provided with a third shut-off valve 630 that opens or closes the bypass line L3.

In the first embodiment shown in FIG. 2, since the BOG discharged from the storage tank T and sent to the gas combustion unit is branched upstream of the heat exchanger 100, only the BOG discharged from the storage tank T and sent to the multistage compressor 200 is used as a refrigerant in the heat exchanger 100.

According to the third embodiment, however, since the BOG is sent to the gas combustion unit through the second discharge line L2 branched downstream of the heat exchanger 100, both the BOG discharged from the storage tank T and sent to the gas combustion unit and the BOG discharged from the storage tank T and sent to the multistage compressor 200 are used as a refrigerant for the heat exchanger 100.

Accordingly, the heat exchanger 100 of the BOG reliquefaction system according to this embodiment can have higher cooling efficiency than that of the BOG reliquefaction system according to the first embodiment. As the cooling efficiency of the heat exchanger 100 is increased, the amount of reliquefied BOG increases and surplus BOG is reliquefied or sent to the gas combustion unit, thereby reducing the amount of BOG to be sent to and burnt by the gas combustion unit.

The heat exchanger 100 according to this embodiment is designed to have a larger capacity than the heat exchanger according to the first embodiment in order to accommodate the BOG sent to the gas combustion unit.

The BOG reliquefaction system included in the vessel according to this embodiment allows some or all of the BOG generated in the storage tank T to be sent to and burnt by the gas combustion unit through the second discharge line L2, and thus can prepare for the case where an excess of the BOG is generated in the storage tank T, for example, upon loading liquefied natural gas and the like.

As in the first embodiment, the bypass line L3 according to this embodiment may be used in order to satisfy the intake pressure condition of the multistage compressor 200 even when the pressure of the storage tank T is reduced, 1) in the case where the heat exchanger cannot be used, for example, upon overhaul or failure of the heat exchanger 100, 2) for removal of condensed or solidified lubricant oil when the fluid channel of the heat exchanger 100 is clogged by condensed or solidified lubricant oil, 3) when there is no need for reliquefaction of BOG due to little surplus BOG, 4) when there is a need for reliquefaction of BOG due to increase in the amount of BOG (that is, upon start or restart of BOG reliquefaction), 5) for satisfaction of the intake pressure condition of the multistage compressor 200 when the internal pressure of the storage tank T is low, and 6) in the cases where the internal pressure of the storage tank T is reduced to low pressure.

As in the first embodiment, the BOG reliquefaction system provided to the vessel according to this embodiment may further include a gas/liquid separator 400 disposed downstream of the pressure reducer 300 to separate the BOG remaining in a vapor phase from liquefied natural gas generated by reliquefaction of the BOG through the multistage compressor 200, the heat exchanger 100 and the pressure reducer 300.

As in the first embodiment, according to this embodiment, the liquefied gas separated by the gas/liquid separator 400 may be sent to the storage tank T and the BOG separated by the gas/liquid separator 400 may be combined with the BOG discharged from the storage tank T and be sent to the heat exchanger 100.

In the BOG reliquefaction system according to this embodiment, a second control valve 520 for controlling the flux of BOG and opening/closing of the corresponding line may be disposed on the line through which the gaseous BOG separated by the gas/liquid separator 400 is discharged.

It will be apparent to those skilled in the art that the present invention is not limited to the embodiments described above and various modifications, changes, alterations, and equivalent embodiments can be made art without departing from the spirit and scope of the invention.

1. A BOG reliquefaction system for ships comprising:
a multistage compressor compressing BOG;
a heat exchanger cooling the BOG compressed by the multistage compressor through heat exchange using BOG not compressed by the multistage compressor as a refrigerant;
a pressure reducer disposed downstream of the heat exchanger and decompressing a fluid cooled by the heat exchanger; and
a bypass line through which BOG is supplied to the multistage compressor after bypassing the heat exchanger,
wherein the BOG compressed and increased in temperature by the multistage compressor is supplied to a hot fluid channel of the heat exchanger.

2. The BOG reliquefaction system for ships according to claim 1, wherein the BOG is supplied to the multistage compressor after bypassing the heat exchanger along the bypass line when the heat exchanger cannot be used and/or when there is no need for reliquefaction of the BOG.

3. (canceled)

4. The BOG reliquefaction system for ships according to claim 1, wherein the BOG discharged from the storage tank is used as a refrigerant in the heat exchanger, and some or all of the BOG is supplied to the multistage compressor after bypassing the heat exchanger along the bypass line to satisfy an intake pressure condition of the multistage compressor, when a pressure of the BOG supplied to the multistage compressor does not satisfy the intake pressure condition of the multistage compressor and/or when there is a need to reduce an internal pressure of the storage tank to low pressure.

5. (canceled)

6. (canceled)

7. The BOG reliquefaction system for ships according to claim 1, wherein a process of supplying the BOG compressed and increased in temperature by the multistage compressor to the hot fluid channel of the heat exchanger is continued for a predetermined period of time to remove residues or foreign matter from the heat exchanger.

8. (canceled)

9. The BOG reliquefaction system for ships according to claim 7, wherein the compressor comprises at least one oil-lubrication type cylinder, and the residues comprise BOG compressed by the compressor and sent to the heat exchanger upon previous BOG reliquefaction and lubricant oil mixed with the BOG compressed by the compressor.

10. (canceled)

11. (canceled)

12. The BOG reliquefaction system for ships according to claim 9, wherein, after the predetermined period of time has elapsed, the BOG is reliquefied by supplying BOG to a cold fluid channel of the heat exchanger so as to be used as a refrigerant in the heat exchanger.

13. (canceled)

14. (canceled)

15. (canceled)

16. The BOG reliquefaction system for ships according to claim 1, wherein the heat exchanger comprises a microchannel type fluid channel.

17. (canceled)

18. A BOG reliquefaction method for ships, comprising:
1) compressing BOG by a multistage compressor;
2) cooling the BOG compressed by the multistage compressor through heat exchange by a heat exchanger using BOG not compressed by the multistage compressor as a refrigerant; and
3) decompressing a fluid cooled by the heat exchanger by a pressure reducer,
wherein the BOG is supplied to the multistage compressor after bypassing the heat exchanger along a bypass line and wherein the BOG compressed and increased in temperature by the multistage compressor is supplied to a hot fluid channel of the heat exchanger.

19. (canceled)

20. The BOG reliquefaction method for ships according to claim 18, wherein the multistage compressor comprises at least one oil-lubrication type cylinder, and, when a fluid channel of the heat exchanger is partially or completely blocked by condensed or solidified lubricant oil, the BOG is supplied to the multistage compressor after bypassing the heat exchanger along the bypass line.

21. The BOG reliquefaction method for ships according to claim 18, wherein it is determined that it is time to remove the condensed or solidified lubricant oil, if performance of the heat exchanger is decreased to 60% to 80% of normal performance thereof.

22. The BOG reliquefaction method for ships according to claim 18, wherein it is determined that it is time to remove the condensed or solidified lubricant oil based on at least one of a temperature difference between upstream of a cold fluid channel of the heat exchanger and downstream of a hot fluid channel of the heat exchanger (hereinafter, ‘temperature difference of a cold flow’); a temperature difference between downstream of the cold fluid channel of the heat exchanger and upstream of the hot fluid channel of the heat exchanger (hereinafter, ‘temperature difference of a hot flow’); and a pressure difference between upstream and downstream of the hot fluid channel (hereinafter, ‘pressure difference of the hot fluid channel’).

23. The BOG reliquefaction method for ships according to claim 22, wherein it is determined that it is time to remove the condensed or solidified lubricant oil, when a state in which a lower value between the temperature difference of the cold flow and the temperature difference of the hot flow is a first preset value or more continues for a predetermined period of time or more or when a state in which the pressure difference of the hot fluid channel is a second preset value or more continues for a predetermined period of time or more.

24. (canceled)

25. (canceled)

26. (canceled)

27. The BOG reliquefaction method for ships according to claim 18, wherein BOG discharged from the storage tank is used as a refrigerant in the heat exchanger, and some or all of the BOG is supplied to the multistage compressor after bypassing the heat exchanger along the bypass line to satisfy an intake pressure condition of the multistage compressor, when a pressure of the BOG supplied to the multistage compressor does not satisfy the intake pressure condition of the multistage compressor and/or when there is a need to reduce an internal pressure of the storage tank to low pressure.

28. (canceled)

29. (canceled)

30. (canceled)

31. (canceled)

32. (canceled)

33. (canceled)

34. The BOG reliquefaction method for ships according to claim 18, wherein a process of supplying the BOG compressed and increased in temperature by the multistage compressor to the hot fluid channel of the heat exchanger is continued for a predetermined period of time to remove residues or foreign matter from the heat exchanger.

35-44. (canceled)
